(19) United States
(12) Patent Application Publication
(10) Pub. No.: US 2009/0251307 A1
(43) Pub. Date: Oct. 8, 2009

(54) BRAKE LIGHT INDICATOR FOR THE FRONT END OF AN AUTOMOBILE

(76) Inventor: Mario Anthony Munoz, SR., Santa Monica, CA (US)

Correspondence Address: Mario Antonio Munoz, Sr., 3014 Pearl Street, Santa Monica, CA, 90405-3015, US

(21) Appl. No.: 12/098,413

(22) Filed: Apr. 5, 2008

(51) Int. Cl. B60Q 1/44

(52) U.S. Cl. 340/479

(57) ABSTRACT

This is a red and or dark orange brake light indicator to be located on the front end of an automobile. The purpose of this light is to provide braking information to the driver of each automobile and pedestrians entering an intersection or anytime visual automobile braking or stopping indication is needed in front of an automobile.

### BACKGROUND OF THE INVENTION

The object of the present invention is intended to provide automobile braking information with a red and or dark orange light to each driver entering an intersection.

U.S. Pat. No. 5,779,345 is a Hood Ornament Light not intended for indicating a signal of braking. This light is intended to display a signal of presence to another car that can be seen from each side of the automobile. U.S. Pat. No. 5,072,340 is a turn signal light that is visible to the driver. U.S. Pat. No. 6,172,598 B1, The Vehicle Motion Indicator is a large turning key shaped mechanism located on the back of an automobile with a brake light attachment.

U.S. Pat. No. 4,401,972, The Stop Light Monitor Device is a monitoring device to notify the driver when a brake light is not working. This is a very much needed patent to insure the safety of all of us.

The Vehicle Communication Device U.S. Pat. No. 5,905,434; The Message Display Unit For Motor Vehicles. U.S. Pat. No. 5,574,428; The Rear Combination Lamp Assembly For Vehicles, U.S. Pat. No. 4,868,719; The Automotive Brake Light and Communication System, U.S. Pat. Nos. 4,868,542; 4,574,269, The Vehicle Communicator; The Signal System For Vehicles, U.S. Pat. No. 4,431,984; The Automotive Communication, U.S. Pat. No. 4,61,828; The Visual Display System, U.S. Pat. No. 3,750,138; The Enhanced Auxiliary Signaling Device, U.S. Pat. No. 5,426,414; The combined Message Display And Brake Light, U.S. Pat. No. 4,928,084; The Vehicular Communication Device, U.S. Pat. No. 5,053,746 and The Vehicular Goodwill Message System, U.S. Pat. No. 5,500,638 are all designed to direct light signals towards the back of an automobile.

The Vehicle-Mounted Electronic Display System, U.S. Pat. No. 5,12,666 is attached to the top or dashboard of an automobile. This system is connected to a word programming processor. This device is not connected to the brake lights and is not intended to be a brake light indicator. The Vehicle Communication Device, U.S. Pat. No. 4,949,071 provides a communication device for use in the back and side window of an automobile.

The present invention provides safety by displaying automobile braking information to the driver of each automobile entering an intersection when the traffic light has turned yellow or red and at stop signs. Many intersections now have cameras recording every move including many accidents caused because there is no indicator on the front end of an automobile communicating to each driver when an automobile is intending to stop or continue through the intersection against a yellow or red light. Further safety is provided to pedestrians by indicating automobile braking in a crosswalk.

The known prior art relating to brake light indicators located on the front of an automobile includes the following U.S. Pat. Nos. 5,779,345; 5,072,340; 6,172,598 B1; 4,401,972; 5,905,434; 5,574,428; 4,868,719; 4,868,542; 4,574,269; 4,431,984; 4,361,828; 3,750,138; 5,426,414; 4,928,084; 5,053,746; 5,500,638; 4,949,071 and 5,132,666.

### SUMMARY OF THE INVENTION

The present invention provides a red and or dark orange automobile brake indicator light designated by reference numeral 20 and a frame 10 holding a (LED) or incandescent light (not shown) and a back plate 30 with an aperture 3 allowing the light wires designated by reference numerals 1 and 2 to extend outward from the back of the light. The present invention is intended to be formed in any shape needed on the front of an automobile.

The brake indicator light is intended to be located on the front end of an automobile providing braking information to each automobile entering an intersection with a red and or dark orange light directed forward on the front end of an automobile located in and around any location of the interior and or exterior front end of all automobile.

### BRIEF DESCRIPTION OF THE DRAWINGS

FIG. 1, is a front plan view of the preferred embodiment.

FIG. 2, is a back plan view of the preferred embodiment.

### DETAILED DESCRIPTION OF THE PREFERRED EMBODIMENT

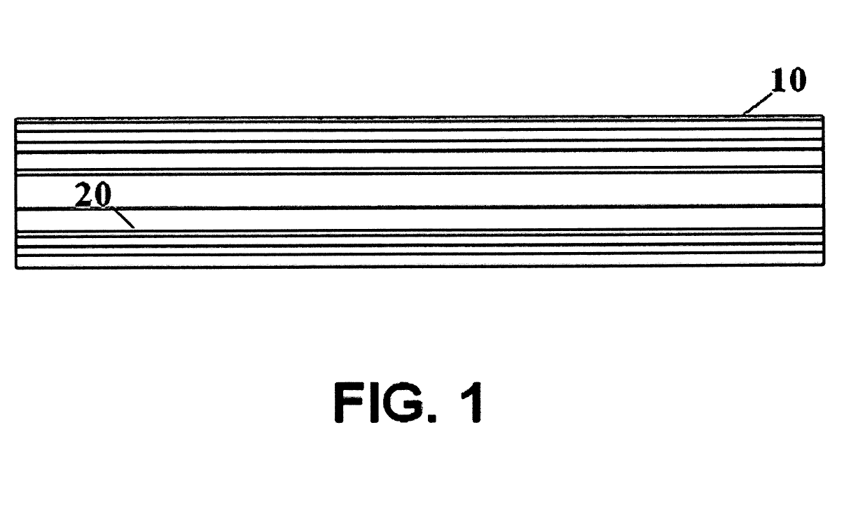

FIG. 1, of the preferred embodiment displays a front plan view of the brake light indicator designated by reference numeral 20 being red and or dark orange color. Reference numeral 10 represents the frame holding the brake light indicator and the back plate 30 (not shown) to be located in and around the front end of an automobile.

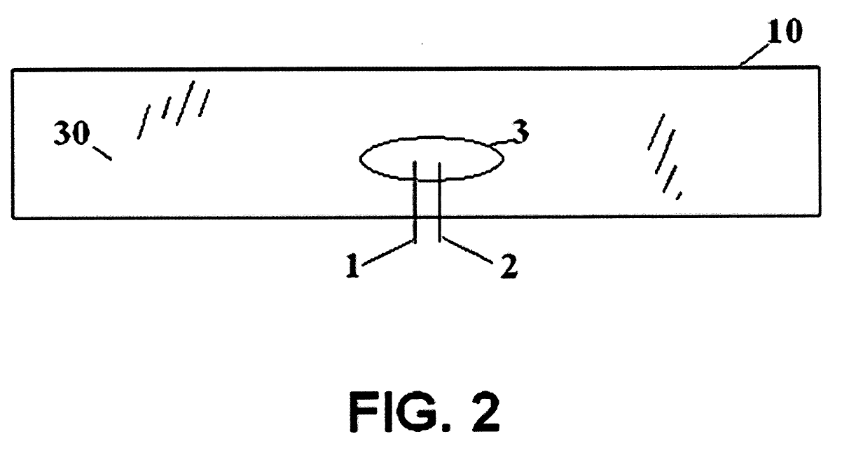

FIG. 2 of the drawings is a back plan view of the brake light indicator displaying the back plate designated by reference numeral 30 and brake light frame 10 holding the brake light indicator 20 (not shown) and the back plate 30 in place. Back plate 30 includes an aperture 3 for the brake light wires to extend outward. The brake light indicator wires are designated by reference numerals 1 and 2.

The light source, non flashing (not shown) in the drawings may be a light emitting diode (LED) or an incandescent. The shape of the present invention is not limited to a rectangular shape as seen in FIG. 1 and FIG. 2. The shape of the present invention may be square, round or any other shape located inside or outside and on or around the head lights; parking lights; hood, windshield; windshield frame; dashboard; turn signals; rear view mirrors or any location on the front end of an automobile, including wrap around capability of the front fender or bumper.

I claim:

1. A brake light indicator to be located on the front of a automobile comprising:
a red and or dark orange light.

2. The invention as defined in claim 1 includes a brake light indicator to be located inside or outside and on or around the head lights; parking lights; turn signals; hood; rear view mirrors; windshield; windshield frame and dashboard.

3. The invention as defined in claim 1 wherein the shape of the brake light indicator is round; square; rectangular or other shapes.

4. The invention as defined in claim 1 includes a wrap around capability on a front fender or bumper.
